(19) United States
(12) Patent Application Publication
(10) Pub. No.: US 2004/0208547 A1
(43) Pub. Date: Oct. 21, 2004

(54) QoS based protection of mesh-based intelligent optical networks

(75) Inventors: Jose H. Sabat, Westin, FL (US); Michael McLaughlin, Wellington, FL (US); Andre Kauffman, Delray Beach, FL (US); Benny Lederman, Boca Raton, FL (US); Fabiano Meneses, Boca Raton, FL (US); A. M. Kabakcioglu, Boca Raton, FL (US)

Correspondence Address: Akerman, Senterfitt & Eidson, P.A., Post Office Box 3188, West Palm Beach, FL, 33402-3188, US

(73) Assignee: Boca Photonics Inc.

(21) Appl. No.: 10/020,032

(22) Filed: Dec. 14, 2001

(51) Int. Cl. H04B 10/08; H04J 14/02

(52) U.S. Cl. 398/50

(57) ABSTRACT

In a communications network, a method and apparatus for providing QoS parameters based protection against network failure scenarios. The invention selectively allocates network resources for protection of a network communication service based on a QoS parameter requirement for the particular network communication service. An alarm provides notification of a failure scenario disrupting network resources interrupting the network communication service. In response to the alarm notification, the system automatically switches a path of the network communication service to make use of the network resources, which have been pre-allocated for protection of the network communication service.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND OF THE INVENTION

1. Field of the Invention

The present invention relates generally to methods for providing network survivability for a Mesh-Based Intelligent Optical Networks (ION), and more specifically to a protection technique using quality-of-service (QoS) parameters for determining the protection optical path on a mesh-based ION.

2. Description of the Related Art

As networks operators are preparing for the transition from the Ring-Based SONET/SDH Network to the more economical mesh-based ION, survivability has become a critical network design criterion. Survivability is a strength of Ring-Based SONET/SDH Network, offering fast built-in protection mechanisms (on the order of 50 ms), contrasting with mesh-based ION survivability for which faster and more cost efficient survivability solutions are needed. Consequently, an important requirement in the design of mesh-based ION involves survivability, which is defined as the ability of the network to recover from failure scenarios affecting network resources. The network services that provide survivability are named protection and restoration techniques. Protection techniques offer pre-planned solutions based on pre-designed schemes for recovery from failure scenarios. Protection techniques lead to faster recovery than restoration methods that try to allocate available resources and take possible actions after the failure scenario has been detected. The allocation of network resources for protection resources is done during network design and may be repeated incrementally at any change in network resource allocations.

The main network resources of a mesh-based ION are Optical Cross-Connect (OXC) and Dense Wavelength-Division Multiplexing (DWDM) optical channels. Other relevant network resources of a mesh-based ION are Transponders, failure sensors and alarm handling modules. DWDM technology allows an optical fiber to carry many optical channels, each at a different wavelength 8, creating tremendous saving and bandwidth. The optical channels are arranged in pairs, one to each direction. Therefore, it is more common to consider each pair as a bi-directional optical channel. OXC located at the network optical nodes provide switching between these different bi-directional optical channels and possibly wavelength conversion. The result of these developments allows the transformation from the Ring-Based SONET/SDH Network to mesh-based ION, consisting of freely connected optical nodes with many redundant interconnections between optical nodes. It should be noted that the phrase mesh is used to denote arbitrary connected optical nodes, which are typically a partial mesh structure rather than a full mesh topology. Mesh-based ION has better capacity utilization than Ring-Based SONET/SDH Network and therefore is preferred, especially in the backbone. The network resource that is allocated to carry working traffic associated with a bi-directional demand from ingress optical node to an egress optical node of the mesh-based ION is referred to herein as an optical path. An optical path is a concatenation of the optical channels between the optical nodes, which in this case are comprised of OXCs. The OXCs along the optical path have to be configured by properly switching the incoming optical channel to the outgoing optical channel, so that the optical path is connected from one end to the other one. When an optical path is created with the purpose of protecting against a failure scenario affecting an existing optical path, it is referred as protection optical path.

Provisioning of mesh-based ION network involves assigning network resources (working optical channel) to optical path based on demands from the users of the network. Given a demand matrix with a set of bi-directional optical path requests between end-to-end optical nodes in the mesh-based ION, the network design method used for: a) setting up bi-directional optical path, b) routing and c) assigning wavelengths for each optical path is commonly referred to as the Routing and Wavelength Assignment (RWA) problem. Generally a network design needs to take into account survivability requirements. In this case, the solution to the RWA problem attempts to minimize network costs, taking into account not only the provisioning of optical paths, but also the assignment of protection spare optical channel capacity to protect the allocated working optical channel against supported failure scenarios. The RWA process assigns optical channels to the optical paths and as a result determines the exact switching necessary for each OXC. There are a variety of conventional and well known algorithms for the solution of the RWA problem using methods such as integer linear programming, simulated annealing, and heuristics, which are designed to achieve quickly a near optimum solution rather than an optimum one. The RWA problem can be solved at the beginning of network configuration phase (static RWA) or during network operation, in response to new optical path demands from the mesh-based ION (dynamic RWA).

In general, networks are designed to support a variety of network communication services with different characteristic and service requirements. Network resource allocation in networks that fail to account for QoS aspect of this different network communication service may waste resources. In the case of scarce network resources, such schemes may not allocate network resources to the network communication service that have the greatest need. Packed-Based Networks have been using differentiated network communication service (e.g., ATM, MPLS) to allocate resources based on QoS metrics such as delay and packet loss. However, such QoS metrics that guide the allocation of resources in these types of packet-based networks have not been used for mesh-based ION. There has also been some limited interest to adopt a differentiated optical services model for the mesh-based ION along the lines of the Differentiated Services (DiffServ) model that is specified by Internet Engineering Task Force (IETF) for the IP Centric Network. However, QoS parameters that express traffic qualities of Packed-Based Networks such as delay and jitter are not suitable for the mesh-based ION that is very different than the IP Centric Network. Therefore, new approaches are necessary to provide such differentiated services that express QoS closely related to the service type and characteristics in the mesh-based ION.

### SUMMARY OF THE INVENTION

The present invention defines a system and method for providing network survivability on a mesh-based ION, and more specifically defines protection techniques using quality-of-service (QoS) parameters for determining the most efficient protection optical path for protecting network communication service against pre-defined failure scenarios.

A network allocation processor selectively allocates network resources for protecting the network communication service based on its QoS requirement. The system also includes an alarm-handling module provided for receiving an alarm notification of a failure scenario disrupting network communication service. A switching controller responsive to the alarm handling module automatically causes switching of the network communication service from the failed communication path to another path making use of the network resources, which has been pre-allocated for protection of this network communication service.

According to one aspect of the invention, the communications network is a mesh-based ION, the network communication service is an optical path, and the network nodes are optical nodes comprised of OXC. According to another aspect of the invention, the network allocation processor is responsive to a demand for network communication service containing at least one QoS parameter, where the QoS parameter specifies the QoS requirement for the network communication service. The QoS parameter can comprise one or more of the following:

a) A qualitative service name for identifying the QoS in qualitative terms;

b) A quantitative value for defining the QoS performance requirement;

c) A priority rule with regard to sharing the network resources allocated for protection;

d) A preemption rule for preempting use of the network resources allocated for protection.

The QoS parameter can also be related to a network resource identifying the relative cost for providing the service. For example, the QoS parameter can be related to a network resource parameter that specifies a maximum number of OXC allowed to be switched in order to protect a network communication service in case of a failure scenario. In such case, the pre-configured OXCs on the protection optical path can be considered a shared network resources to be allocated during the network design process.

According to another aspect of the invention, the network allocation processor compiles a demand matrix, which can include demand requirements data such as a capacity requirement, source/destination information and preferably at least one QoS parameter for specifying the QoS requirement for the network communication service. The network allocation processor advantageously utilizes the demand matrix to perform an optimum network design, routing a network communication service on a provisioned optical path and simultaneously allocating protection optical channel capacity, taking into account QoS requirements. The network allocation processor can perform the optimum network design analysis either at an initial phase of the network design before the network is operating, or while the network is actively operating after an incremental change to the demand matrix.

### BRIEF DESCRIPTION OF THE DRAWINGS

FIG. 1 is a block diagram showing an optical node of a communications network, including an OXC

FIG. 2 is a block diagram showing a network of OXCs.

FIG. 3 is a block diagram showing a network of OXCs illustrating the concept of span-based protection.

FIG. 4 shows a block diagram of a network of OXCs illustrating the concept of path-based protection.

FIG. 5 illustrates an optical path demand matrix

FIG. 6A is a block diagram of a network of OXCs that are not pre-configured for protecting a given failure scenario f2.

FIG. 6B is a block diagram of a network of OXCs where the OXCs along the protection optical path are pre-configured for a given failure scenario f2.

FIG. 7 is a block diagram illustrating the final optical node configurations for the network in FIGS. 6A and 6B after the occurrence of the failure scenario f2.

FIG. 8 shows a block diagram of a network of OXCs, illustrating the concept of shared network resources.

FIG. 9 is a flowchart useful for illustrating the steps involved in the incremental design and optimization of a survivable mesh-based ION based on QoS parameters.

### DETAILED DESCRIPTION OF THE INVENTION

The present invention provides a method and apparatus for a mesh-based ION with protection to satisfy multiple user-specified QoS parameters. Based on these QoS parameters, the present invention provides a new network design method for mesh-based ION introducing the concept of master optical nodes. This new network design method creates the most efficient protection optical path for protecting network communication service against pre-defined failure scenarios, minimizing the amount of network resources required and enabling fast protection. The present invention thereby makes fast protection in mesh-based ION feasible and cost effective, driving span-based protection in the sub 50 ms range, similar to ring-based SONET/SDH.

The invention incorporates a number of new concepts including the concept of QoS parameters, master optical node, and a new network design method with QoS parameters. A brief discussion of each of these parameters follows.

QoS Parameter

The present invention introduces the concept of QoS parameters associated with the quality of the protection required for a given demand matrix in order to make improved use of network resources. According to a preferred embodiment of the present invention, each entry of the demand matrix includes ingress optical node and egress optical node (ingress optical node and egress optical node are interchangeable as the system makes use of bi-directional optical channels), and other related parameters. There are a wide variety of ways in which QoS parameters can be implement as part of the RWA. Following are two examples of possible approaches defined by a standard sequence data type or tuple (a number of values separated by commas), which can be used with the present invention. The first approach focuses on the protection of optical fiber cables. The second approach focuses on the protection of optical paths. It will be readily appreciated that the present invention is not limited to the specific embodiments described herein, which are merely exemplary.

a) Optical Fiber Cable Approach

<Optical Fiber Cable, Optical Fiber Cable Capacity, QoS Parameter (s)>

In the above tuple, the parameter “optical fiber cable” identifies the optical fiber cable to which the tuple is related. The “optical fiber cable capacity” parameter specifies the data handling capacity requirement of the optical fiber cable.

Optical fiber cable cut is the most common reason for failure with the current technology. The Shared Risk Link Group (SRLG) concept classifies all of the optical fiber that may be affected by the same optical fiber cable cut. Optical fiber bundled in the same optical fiber cable or right-of-way belongs to the same SRLG since they share the same risk of a optical fiber cable cut. It is possible that certain portions of the network are more prone to optical fiber cable cuts than others. Therefore a QoS parameter for fast protection that is directly associated with an optical fiber cable cut for a given span could be used.

b) Optical Path Approach

<Optical Path, Optical Path Capacity, QoS Parameter (s)>

In the above tuple, the parameter “optical path” identifies the optical path to which the tuple is related. The “optical path capacity” parameter specifies the data handling capacity requirement of the optical path.

The “QoS parameter (s)” are preferably defined at 3 QoS Levels, namely QoS first level, QoS Second Level and QoS Third Level. These 3 QoS Levels are described below.

According to one embodiment of the present invention, there are no restrictions on the number and values of QoS parameters associated with the QoS first level and for the corresponding QoS Second Level and QoS Third Level. These QoS parameters can be arranged according to the technology of the day and the expectations of the users. The user can have access to QoS first level and QoS Second Level, and can choose one or more of the QoS parameters named in the QoS first level. The QoS Third Level is mainly accessible by the Network Operator.

There are four QoS first level classes of QoS parameter, defined as:

a) A qualitative term based on the duration to recover from a failure scenario.

In function of the relative duration to recover from a failure scenario, this QoS first level can be named as:

1) QoS first level Slow,

2) QoS first level Medium,

3) QoS first level Fast.

For the QoS first level Fast, this duration is expected to be close to 50 ms, similar to Ring-Based SONET/SDH.

b) A quantitative value based on the QoS performance requirement;

c) A priority parameter based on priority rules with regard of sharing the network resources allocated for protection;

1) Protect With Assigned Priority Rule: This priority rule means that the optical path in question requires special allocation of protection resources during network design. During a failure scenario, reserved pre-planned protection optical channel capacity will be used to protect that optical path.

2) Protect If Possible Rule: This priority rule means that the optical path in question requires no special allocation of protection resources during network design. However, if during a failure scenario, available capacity can be used to protect that optical path then the corresponding optical path will be protected.

3) Don't Protect Rule: This priority rule means that the optical path in question requires no special allocation of protection resources during network design and during a failure scenario, no attempt to protect that optical path will be done.

d) A priority parameter based on preemption rules for network resources allocated for protection.

1) Preemptive Rule: This preemption rule is used for resolving network resources conflicts in the case of multiple failure scenarios. If, due to a new failure scenario, there is a need to use some of the network resources that are actively used at that time for the protection of an existing failure scenario, then the Preemptive Rule decides whether this is possible.

The QoS Second Level preferably involves statistical information and provides statistical values of protection performance based on real data from the network. The statistical information can include standard statistical parameters such as expected values, variation of corresponding QoS parameters based on real values from the network. In order to provide these statistical parameters, the network incorporates apparatus to measure and monitor the currently supported statistical parameters of the service and to update these if they change according to network conditions.

The QoS Third Level provides information on the incremental network resources required in order to implement the protection schemes as defined by QoS first level. The QoS Third Level information is preferably known only by the Network Operator.

Master Optical Node

The present invention introduces the concept of a master optical node, which represents a new concept for the current art of span-based protection and path-based protection. This concept is fundamental for achieving QoS first level Fast protection performance on mesh-based ION. According to one embodiment of the present invention, the following assumptions are related with the concept of master optical node:

1) An optical node assumes the role of master optical node for a given failure scenario in the following conditions:

a) The OXC on the optical node is part of the optical path(s) that are affected by the failure scenario, and

b) The alarm handling module on the optical node directly detects the failure scenario (i.e., possibly neighboring optical nodes of the failed optical channel).

2) The protection optical path consists of protection optical channels starting from one master optical node and ending in the other master optical node, routing the original optical path around the failed optical channel. There is one protection optical path for each optical channel in the optical path that needs to be protected. Each protection optical path may pass through several intermediate optical nodes in order to connect both master optical nodes.

3) The aim of the present invention is to have the protection optical path created by actions taken exclusively by the two master optical nodes without intervention of intermediate optical nodes, which will lead to the fastest protection. However, due to QoS parameter requirements and cost restriction this is not always achieved. In the case the protection optical path does not have all of its optical channels already pre-connected on the intermediate optical nodes, then the master optical node has to send messages to the intermediate optical nodes in order to establish the protection Optical path, which will lead to a slower protection.

4) The current technology uses bi-directional optical channels, hence the protection optical paths are considered bi-directional as well. It should be noted however, that actually there are two optical channels that make up a bi-directional protection optical path, one optical channels in each direction. The discussion will continue with the bi-directional protection optical path assumption, however, should the technology change this does not effect the master optical node concept, since there is no restriction on directionality.

5) If the two master optical nodes for a given failure scenario are ingress and egress optical nodes of the optical path, then the protection technique for that failure scenario is equivalent to path-based protection. Thus it can be observed that the master optical node concept allows different protection techniques to work in harmony in the same communications network. In addition, in the current invention, the location of master optical nodes for a given failure scenario is not limited to ingress, egress or neighbor optical nodes. Depending on the current technology, monitoring apparatus, and cost, any other optical node in the network that satisfies the conditions defined above can be designated as the master optical nodes for a given failure scenario.

6) The master optical nodes will have all the necessary information stored locally in tables called OXC Configuration Tables in order to activate the pre-planned protection schemes once a failure scenario event occurs.

New Network Design Method with QoS Parameters

The QoS parameters and associated network resources allocation concepts discussed herein can be applied to modify the prior network design art. In particular, by giving consideration to the QoS parameters in the network design method, the QoS parameters required by the optical paths can now play an important role in allocating the network resources. The present invention allocates network resources depending on the QoS parameters associated with the optical paths. As a result, a new network design method is presented, where QoS parameters add different constraints in the choice of protection optical path. These constraints are as follows:

a) Constraint on Maximum Number of Intermediate Optical Nodes.

The maximum number of intermediate optical nodes that need to take action in order to establish the protection optical path must be compatible with the QoS parameter defined in the QoS first level for the failed optical path. For instance, if a given optical path requires a QoS parameter equal to QoS first level Fast, then the maximum number of intermediate optical nodes that need to take action in order to establish the protection optical path is zero. In this case, the two master optical nodes are the only optical nodes to take action to establish the protection optical path.

b) Constraint on Optical Channel Composing an Optical Path.

The entire optical channel belonging to the optical path must satisfy the constraint on maximum number of intermediate optical nodes defined above.

The preferred embodiments of the present invention are illustrated in the Figures like numerals being used to refer to corresponding parts of the various drawings.

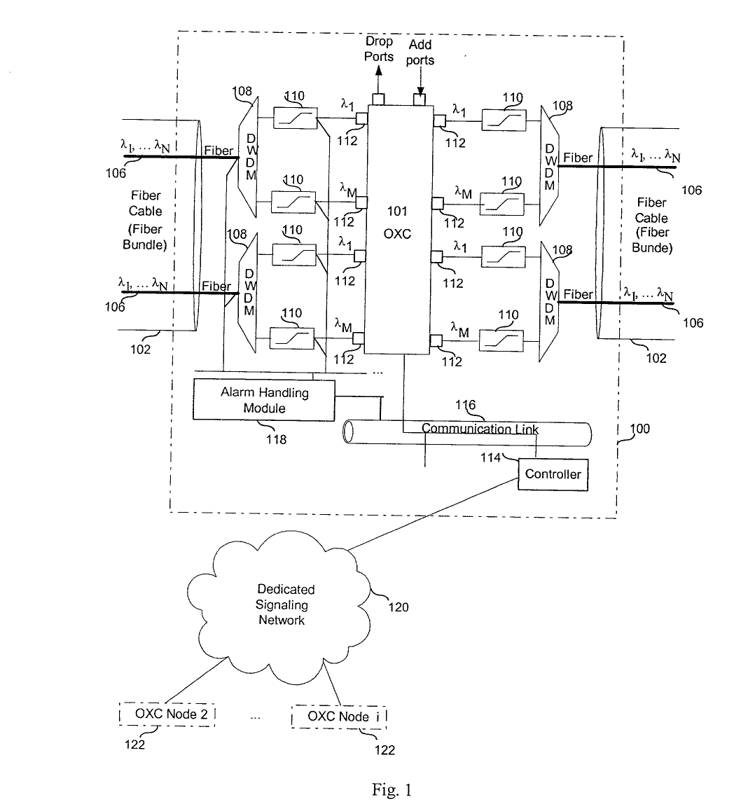

FIG. 1 illustrates an optical node 100 of a communications network, including an OXC 101 and related mesh-based ION network resources, which can provide wavelength routing in accordance with a preferred embodiment of the present invention. A plurality of bundled optical fiber cables 102 provide optical transport capability between optical node 100 and other similar optical node (not shown), which are part of the mesh-based ION. Each optical fiber 106 in the optical fiber cables 102 provides multiple optical channels (wavelength channels) 8₁ . . . 8ₙ which transport the information or traffic (e.g. voice or other data to be communicated) between two optical nodes. Also provided at the optical node 100 are DWDMs 108 and Transponders 110 that connect optical channels to the OXC 101 through OXC Ports 112.

An alarm handling module 118, connected to one or more failure sensors, is advantageously provided for monitoring failure scenarios affecting one or more optical paths. For example, failure sensors (not shown) may be provided at the optical fiber input to the DWDMs 108 and at the Transponders 110. A sufficient number of failure sensors are preferably provided for each of the DWDMs and Transponders so that any failure scenario affecting an optical path will be detected and communicated to the alarm-handling module 118.

An optical node preferably includes an OXC Controller in order to implement the current invention. In the example provided in FIG. 1, the optical node 100 includes the OXC Controller 114. The OXC Controller main functions include providing switching commands to the OXC and receiving alarm notifications from the alarm-handling module. The OXC Controller 114 can communicate with the OXC and the alarm-handling module through a communication link 116. According to a preferred embodiment of the present invention, the communication link 116 may be provided by any suitable arrangement, such as a fast internal bus, an Ethernet connection or wireless command link.

According to a preferred embodiment of the present invention, a dedicated signaling Network 120 is provided for signaling communication and control between optical node 100 and the other optical nodes 122. In FIG. 1, only two additional optical nodes 122 are shown, but it will be understood by those skilled in the art that there may be many such optical nodes that form the mesh-based ION.

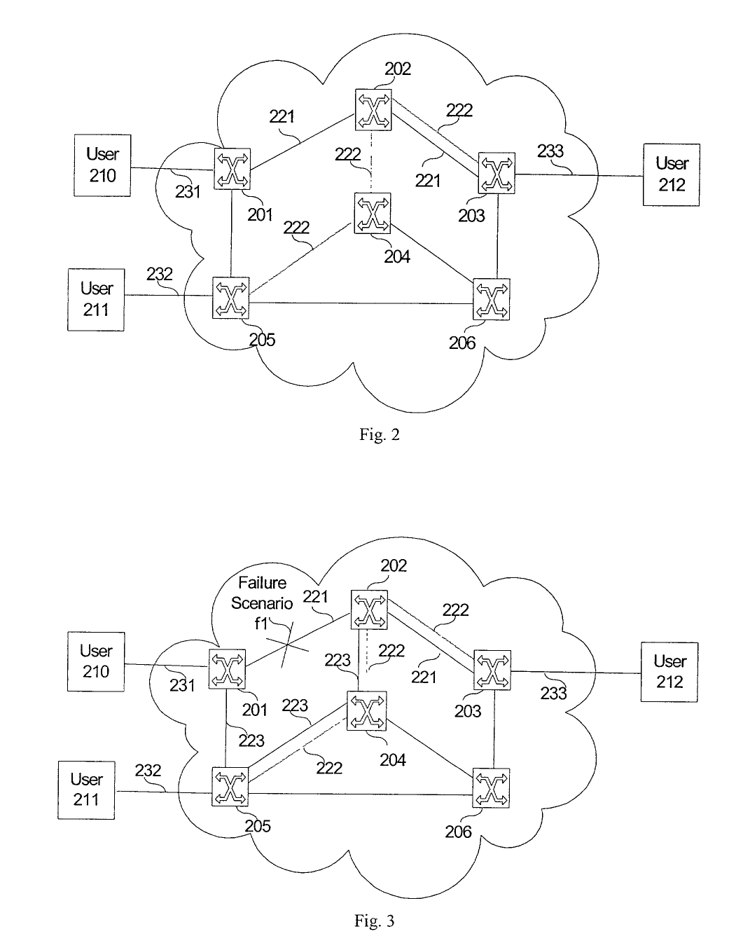

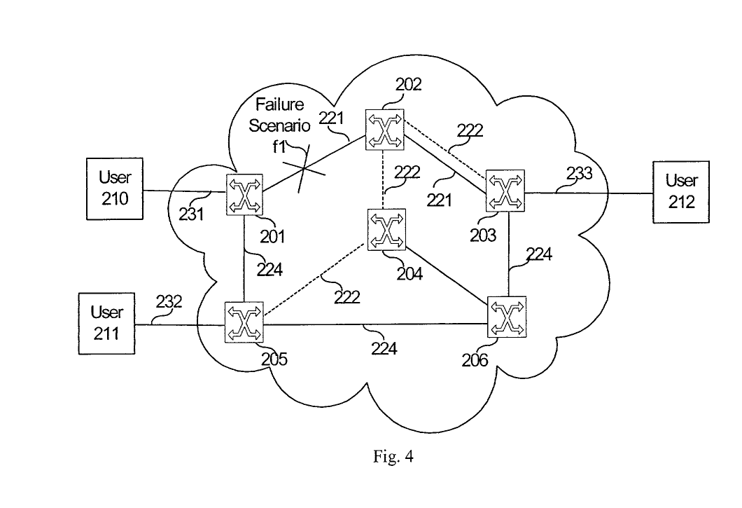

FIG. 2 shows a mesh-based ION comprised of optical nodes 201, 202, 203, 204, 205 and 206 that are utilized by users 210, 211, and 212. FIG. 2 illustrates two optical paths, the first optical path 221 interconnects optical nodes 201 and 203 and the second optical path 222 interconnects optical nodes 205 and 203. The optical path 221 and optical path 222 will be used in FIGS. 3 and 4 to illustrate two protection mechanisms: Span-Based protection is shown in FIG. 3, and the path-based protection is shown in FIG. 4.

In FIG. 3, a failure scenario f1 affecting an optical channel between optical nodes 201 and 202 has occurred, thereby disrupting optical path 221. In Span-Based protection the two optical nodes closest to the failed optical channel, optical nodes 201 and 202, are responsible for rerouting optical path 221 to protection optical path 223, providing an alternate path between optical nodes 201 and 202 and bypassing the disrupted optical channel.

In FIG. 4 by comparison, in the path-based protection shown, the same failure scenario f1 is corrected by utilizing protection optical path 224, which provides an alternate optical path from the ingress optical node 201 to the egress optical node 203. Thus, in path-based protection there is a protection optical path created from the ingress to the egress optical node. Both, the ingress optical nodes 201 and the egress optical nodes 203 are responsible to create the protection optical path 224, but these two optical nodes may not be directly involved with the detection of the failure scenario f1.

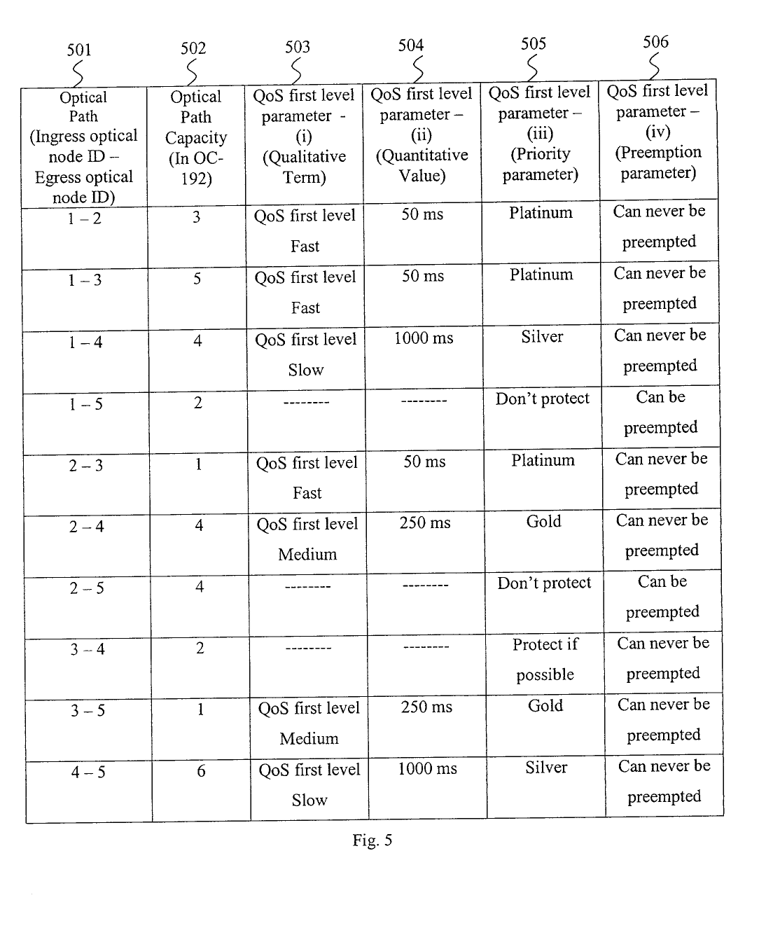

FIG. 5 gives an exemplary demand matrix with the QoS parameters. Each row on the table represents a tuple related with the optical path approach as previously described. Column 501 describes the ingress optical node ID and the egress optical node ID for the given optical path. Column 502 specifies the data handling capacity requirement of the respective optical path. The last four columns (503, 504, 505 and 506) are related to the four QoS first level classes of QoS parameters that can be accessed by the user. The qualitative term that is described in column 503 is a QoS first level parameter based on the duration to recover from a failure scenario. Column 504 gives the corresponding expected value for the duration to recover from a failure scenario. Column 505 describes the priority for the usage of the shared network resources allocated for the protection of the given optical path. At last, column 506 decides whether a network resource that is currently being used by the related optical path at that time can be preempted by a higher QoS parameter Level optical path.

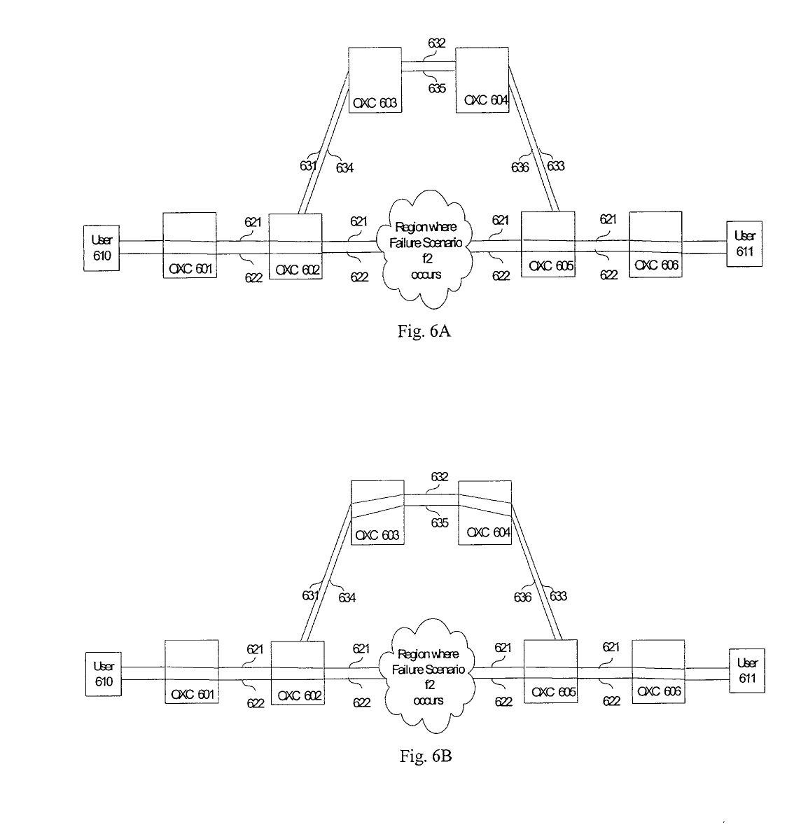

FIG. 6A shows a block diagram of a network of optical nodes with their respective OXC. The OXCs along the protection optical path are not pre-configured for protecting a given failure scenario f2. Consider the optical paths 621 and 622, both originated at optical node 601 and terminated at optical node 606. These optical paths 621 and 622 are providing network communication service between the users 610 and 611. This network communication service will be disrupted in the event of failure scenarios f2, which will be immediately detected by the alarm handling modules of the optical nodes 602 and 605, adjacent to where the failure scenarios f2 occurred. Optical nodes 602 and 605 will assume by definition the role of master optical nodes in order to protect the optical paths 621 and 622 against this failure scenario f2. Using the new network design method, two pre-planned protection optical paths are created in order to protect the optical paths 621 and 622; both originated at OXC 602 and terminated at OXC 605, passing through the OXCs 603 and 604.

Note that there is no pre-set interconnection of optical channel 631 to 632 and optical channel 634 to 635 in the OXC 603. Similarly, there is no pre-set interconnection of optical channel 632 to 633 and optical channel 635 to 636 in the OXC 604. Such implementation requires messages sent from the master optical nodes to the optical nodes 603 and 604 in order to configure their internal switching to create the protection optical paths. The necessity for such messages and post failure scenario configuration of optical nodes 603 and 604 means that additional delays are introduced in the process of protecting the optical paths around the failure scenario f2.

FIG. 6B shows the same network of optical nodes as shown in the previous FIG. 6A with a relevant difference on the way the OXCs of optical nodes 603 and 604 have their cross-connects pre-set. In the diagram of FIG. 6B, there is a pre-set interconnection of optical channel 631 to 632 and optical channel 634 to 635 in the OXC 603. There is also a pre-set interconnection of optical channel 632 to 633 and optical channel 635 to 636 in the OXC 604. Such implementation does not require messages to be sent from the master optical nodes to the optical nodes 603 and 604 in order to configure their internal switching for creating the protection optical paths.

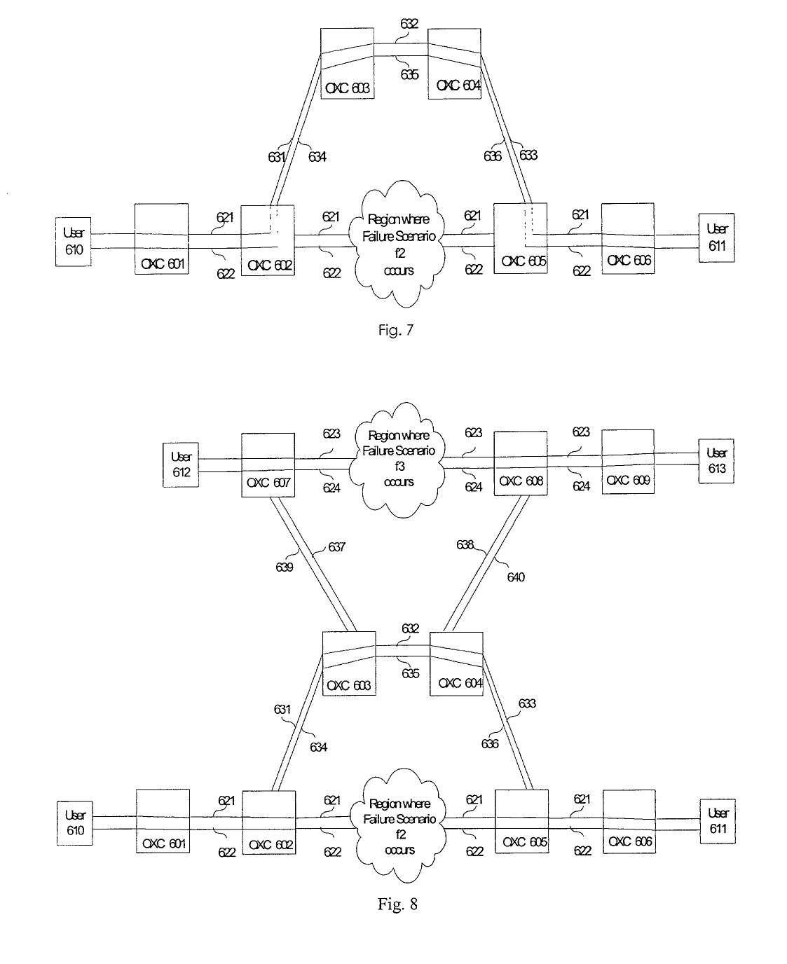

FIGS. 6A and 6B described above show two different ways that are provided by the present invention to handle the failure scenario f2. In both cases the failure scenario f2 is detected by the alarm handling modules of the master optical nodes 602 and 605 and several preplanned actions take place. FIG. 7 depicts the final configuration, for both cases, of the involved optical nodes after the occurrence of the failure scenario f2. After receiving the indication that failure Scenario f2, the master optical nodes 602 and 603 switches to the protection optical path in order to achieve the restored network state of FIG. 7. These are additional actions not shown in FIGS. 6A and 6B.

The present invention recognizes that there is considerable overhead for passing messages and for synchronizing all OXCs in the path to activate the protection optical path as it is done in FIG. 6A. On the other hand, it is recognized that switching only the two masters associated with the failure scenario is the fastest way of providing optical path protection, as it is done in FIGS. 6B and 7. Therefore, whenever a given optical path is assigned to have a QoS first level Fast parameter, the solution described in FIG. 6B is preferred. The other two QoS first level parameters—QoS first level Medium and QoS first level Slow—are associated with the solution described in FIG. 6A. The difference between QoS first level Medium and QoS first level Slow relies on the number of OXCs that must be switched in order to activate a protection optical path and consequently the number of messages that should be sent to different optical nodes. The greater the number of OXCs that must be switched, the slower the recovery from the failure scenario and consequently the slower the QoS first level parameter.

In order to fully appreciate the additional time required to re-route the optical path for the configuration in FIG. 6A, consider the actions that have to be performed by the master optical node 602 in case of a failure scenario f2. Optical node 602, as the master optical node for the failure scenario f2, receives the alarm related with failure scenario f2 and responds to it by sending messages to the optical nodes 603 and 604 to instruct the OXCs 603 and 604 to switch properly, so that the protection optical path is activated. In addition, OXC 602 connects to the activated protection optical path. Note that, for failure scenario f2 there are two master optical nodes. The master optical node 605 also switches to the active protection optical path. In this example, the master optical node 602 is arbitrarily chosen to send messages to optical nodes 603 and 604. The task of sending messages to other participating OXCs in the protection of the failure scenario may be shared between the master optical nodes, or both master optical nodes may send messages for redundancy.

By comparison, there are considerably fewer actions the optical node 602 has to perform if the communications network is initially in the state of FIG. 6B. In the starting configuration shown in FIG. 6B, the dotted lines in OXC at optical nodes 603 and 604 are showing the initially pre-connected optical channels 631 to 632 and 632 to 633, and optical channels 634 to 635 and 635 to 636. As a result, after receiving the failure scenario f2 alarm, the master optical nodes 602 and 605 only need to switch to the protection optical path in order to achieve the restored network state of FIG. 7. The overhead of communicating with the optical nodes 603 and 604, as well as the extra time necessary for the configuration of optical nodes 603 and 604 to activate the protection optical path, is eliminated in restoration from the state in FIG. 6B.

Finally, it should be mentioned that in both cases shown in FIGS. 6A and 6B, once the protection optical path is established (FIG. 7), the master optical nodes are responsible for checking the consistency of the path. This is achieved through a set of messages exchanged between all the optical nodes that belong to the established protection optical path. The process of exchanging these messages is driven by the master optical nodes. However, this occurs after the establishment of the protection optical path. Therefore no delay is introduced in the duration of the recovery process.

FIG. 8 is intended to illustrate the complex problem solved by this new network design method. As explained above, the present invention allocates network resources depending on the QoS parameters associated with the optical paths. As a result a new network design method is presented, where QoS parameters add different constraints in the choice of protection optical path. FIG. 8 shows a block diagram of a network that includes the network previously discussed from FIGS. 6 and 7. In FIG. 8, optical nodes 607, 608 and 609 have been added for optical paths 623 and 624. Both optical paths 623 and 624 originated at optical node 607 and terminated at optical node 609. These optical paths 623 and 624 are providing network communication service between the users 612 and 613. This network communication service will be disrupted in the event of failure scenarios f3, which will be immediately detected by the alarm handling modules of the optical nodes 607 and 608, adjacent to where the failure scenarios f3 occurred. Optical nodes 607 and 608 will assume by definition the role of master optical nodes in order to protect the optical paths 623 and 624 against this failure scenarios f3.

Assuming the QoS parameters for optical paths 621 and 622 are defined by the following tuple that can preferably correspond to the format of the demand matrix of FIG. 5:

| Optical path | Optical | QoS first level | QoS first level | QoS first level | QoS first level |
|---|---|---|---|---|---|
| (Ingress optical | path | parameter - | parameter - | parameter - | parameter - |
| node ID - Egress | Capacity | (i) | (ii) | (iii) | (iv) |
| optical node ID) | (In OC-92) | (Qualitative Term) | (Quantitative Value) | (Priority parameter) | (Preemption parameter) |
| 601-606 | 1 | QoS first level | 50 ms | Platinum | Can never be |
| | | Fast | | | preempted |

Assuming the QoS parameters for optical paths 623 and 624 are defined by the following tuple:

| optical path | optical | QoS first level | QoS first level | QoS first level | QoS first level |
|---|---|---|---|---|---|
| (Ingress optical | path | parameter - | parameter - | parameter - | parameter - |
| node ID - Egress | Capacity | (i) | (ii) | (iii) | (iv) |
| optical node ID) | (In OC-92) | (Qualitative Term) | (Quantitative Value) | (Priority parameter) | (Preemption parameter) |
| 607-609 | 1 | QoS first level | 100 ms | Gold | Can never be |
| | | Slow | | | preempted |

Using the new network design method, which takes into account the above demand matrix, the QoS parameters and the set of Failures Scenarios including f2 or f3, four pre-planned routes for the optical paths 621, 622, 623 and 624 are created with their respective pre-planned protection optical paths.

1) Assume that for economic reasons, the new network design method establishes that the protection optical paths for failure scenario f3 and failure scenario f2 should share the optical channels 632 and 635.

2) Based on the QoS parameter defined for optical paths 621 and 622, the new network design method creates protection optical paths with pre-set interconnections in the OXC 603 or OXC 604. Such implementation doesn't require messages sent from the master optical nodes 602 or 605 to the optical nodes 603 and 604 in order to configure their internal switching to create the protection optical paths.

3) Based on the QoS parameter defined for optical paths 623 and 624, the new network design method creates protection optical paths without pre-set interconnections in the OXC 603 or OXC 604. Such implementation requires messages sent from the master optical nodes 607 or 608 to the optical nodes 603 and 604 in order to configure their internal switching to create the protection optical paths.

The new network design method was able to provide an economical solution based on sharing resources. This was possible because the network was pre-planned for protecting the demand matrix against failure scenarios happening one at a time, and because the combination of QoS parameters allowed the sharing of Network resources. However, if it were required to protect the demand matrix against simultaneous Failures Scenarios f2 and f3, or if the QoS parameter for optical paths were more restrict, then probably it would be necessary to assign additional protection optical channels between optical nodes 603 and 604.

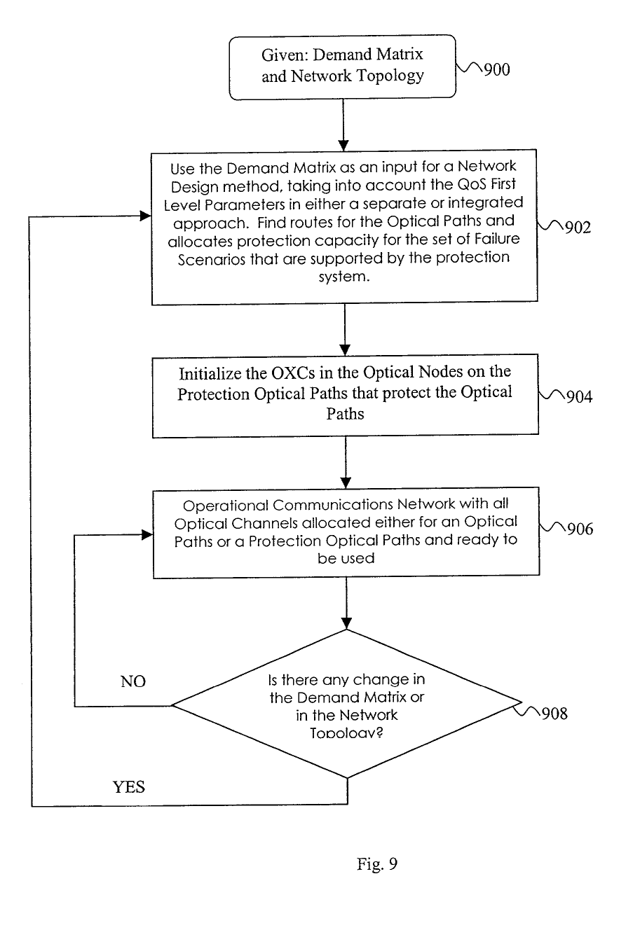

FIG. 9 shows a flow chart describing the network design method. The flowchart begins at step 900 with the system in its initial state for a given demand matrix and network topology. In step 902 the demand matrix is used as an input to obtain an optimum or near optimum allocation of network resources for the given demand matrix. This is done using a conventional network design algorithm that routes the optical paths and allocates protection capacity for the set of failure scenarios that are supported by the protection system. The conventional network design algorithms start with a set of failure scenarios F that need to be restored. The network design algorithm finds the masters for each failure scenario and optimally allocates the protection optical paths for each failure scenario.

While the search for an optimum solution in step 902 is computation intensive, the generation of a candidate solution that satisfies the constraints is relatively easy. In fact, some methods like the well known simulated annealing approach iteratively generates viable network design solutions and use an acceptance criteria to replace the current solution with the new one. After several iterations, the current solution approaches the optimum, and possibly the optimum solution is achieved.

The invention provides the integrated and the separate approach to be applied for the network design. The integrated approach of the invention shown in step 902 integrates the QoS first level parameters in the process of generating a candidate solution in addition to the constraints used in prior art. On the other hand, the separate approach of the invention checks the QoS first level parameters after the candidate network is generated by the existing algorithm. If the QoS first level parameters are satisfied, the acceptance criteria of the method is applied. Otherwise the solution is rejected, without applying the acceptance criteria of the existing method. Those skilled in the relevant art will readily understand how to add the QoS first level parameters to their optimization method.

Regardless of whether the integrated or separate approach is used, in step 904 the generated solution is used to initialize the OXCs in the optical nodes (except the masters) on the protection optical paths that protect the optical paths. In this regard, the initialization process includes providing tables to each master optical node and other relevant optical nodes on the protection optical path that define the set of pre-planned actions to be executed for each potential optical path failure scenario. These tables can be stored by the OXC controller 114 as illustrated in FIG. 1.

As a result of the foregoing optimization and preparation, the protection optical path for each optical path is ready to be used. This is the state of the communications network shown in step 906.

In step 908, the system determines if there is any change in the demand matrix or in the network topology that requires an incremental dynamic re-allocation of network resources. If so, the system cycles back to step 902 where the modified demand matrix or network topology is used to develop a new optimized solution. If in step 908 there is no change in the demand matrix or network topology, the system returns to step 906.

Those skilled in the relevant art may make various changes in form and detail without changing the spirit and scope of the invention. Various aspects of the present invention have been presented by way of example. It should be understood that examples are not limitations on the invention, but rather a method of presentation that illustrates methods and ideas. The present invention therefore should not be limited by any of the examples, but should be defined according to following claims.

We claim:

1. In a mesh type communications network, a method for providing a QoS based protection of network failure scenarios comprising of:
a) allocating network resources for protection of a network communication service, said allocating of said network resources selectively determined based on a QoS parameter requirement for said network communication service;
b) receiving an alarm notification of a failure scenario disrupting network resources of said communications network interrupting said network communication service;
c) responsive to said alarm notification, automatically switching a communication path of said network communication service to make use of said network resources which have been pre-allocated for protection of said network communication service.

2. The method according to claim 1 wherein said communications network is a mesh-based ION and said network communication service is an optical path.

3. The method according to claim 2 wherein said network has at least one optical node comprised of an optical cross connect (OXC).

4. The method according to claim 1 wherein said allocating of said network resources is performed in response to a demand for network communication services, said demand for network communication service containing at least one QoS parameter for specifying said QoS parameter requirement for said network communication service.

5. The method according to claim 4 wherein said QoS parameter comprises at least one of
a) a qualitative term based on the duration to recover from a failure scenario;
b) a quantitative value based on the QoS performance requirement;
c) a priority parameter based on priority rules with regard to sharing the network resources allocated for protection; and
d) a priority parameter based on preemption rules for network resources allocated for protection.

6. The method according to claim 4 wherein said QoS parameter comprises a network resources parameter identifying the relative cost of service in terms of said network resources.

7. The method according to claim 4 wherein said QoS parameter is a network resources parameter that specifies a maximum number of optical nodes that are permitted to be switched on a given optical path in order to provide protection.

8. The method according to claim 1 wherein pre-configured OXCs on a protection optical path are a shared resource to be allocated in a routing and wavelength assignment (RWA) process.

9. The method according to claim 1 wherein said allocating step further comprises of compiling a demand matrix which comprises of a network communication service source/destination information, a network communication service capacity requirement, and at least one QoS parameter for specifying said QoS requirement for said network communication service.

10. The method according to claim 9 wherein said demand matrix is applied to an optimum network design method for network communication service routing and physical channel assignment with allocation of protection capacity.

11. The method according to claim 10 wherein said physical channel assignment is an optical channel.

12. The method according to claim 10 wherein said optimum network design method is applied at an initial phase of said network design, before said network is operating.

13. The method according to claim 10 wherein said optimum network design method is applied while said network is actively operating and an incremental change to said demand matrix is required.

14. In a mesh-based communications network, a system for providing a QoS based protection of network failure scenarios comprising of:
a) a network allocation processor allocating network resources for protection of a network communication service, said network allocation processor selectively allocating said network resources based on a QoS parameters requirement for said network communication service;
b) an alarm-handling module for receiving an alarm notification of a failure scenario disrupting communication between two optical nodes of said communications network interrupting said network communication service;
c) at least one OXC Controller responsive to said alarm notification for automatically causing switching of an optical path of said network communication service to make use of said network resources, which have been allocated for protection of said network communication service.

15. The system according to claim 14 wherein said communications network is a mesh-based ION and said network communication service is an optical path.

16. The system according to claim 15 wherein said network has at least one optical node comprised of an optical cross connect (OXC)

17. The system according to claim 14 wherein said network allocation processor is responsive to a demand for network communication services, said demand for network communication service containing at least one QoS parameter for specifying said QoS parameter requirement for said network communication service.

18. The system according to claim 17 wherein said QoS parameter comprises at least one of:
a) a qualitative term based on the duration to recover from a failure scenario;
b) a quantitative value based on the QoS performance requirement;
c) a priority parameter based on priority rules with regard of sharing the network resources allocated for protection; and
d) a priority parameter based on preemption rules for network resources allocated for protection.

19. The system according to claim 17 wherein said QoS parameter comprises a network resources parameter identifying the relative cost of service in terms of said network resources.

20. The system according to claim 17 wherein said QoS parameter is a network resources parameter that specifies a maximum number of optical nodes that are permitted to be switched on a given optical path in order to provide protection.

21. The system according to claim 14 wherein pre-configured OXCs on a protection optical path are a shared resource to be allocated in a routing and wavelength assignment (RWA) process.

22. The system according to claim 14 wherein said network allocation processor compiles a demand matrix, said demand matrix comprised of a network communication service source/destination information, a network communication service capacity requirement, and at least one QoS parameter for specifying said QoS requirement for said network communication service.

23. The system according to claim 22 wherein said network allocation processor utilizes said demand matrix to perform an optimum network design method for network communication service routing and physical channel assignment with allocation of protection capacity.

24. The system according to claim 23 wherein said physical channel assignment is an optical channel.

25. The system according to claim 23 wherein said optimum network design method is performed by said network allocation processor at an initial phase of said network design, before said network is operating.

26. The system according to claim 23 wherein said optimum network design method is performed by said network allocation processor while said network is actively operating and an incremental change to said demand matrix is required.
